(19) United States
(12) Patent Application Publication
(10) Pub. No.: US 2025/0391094 A1
(43) Pub. Date: Dec. 25, 2025

(54) MODEL GENERATION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Panwang PAN, Beijing (CN); Zeming LI, Beijing (CN); Chenguo LIN, Beijing (CN)

(21) Appl. No.: 19/244,415

(22) Filed: Jun. 20, 2025

(30) Foreign Application Priority Data
Jun. 20, 2024 (CN) 202410798614.2

(51) Int. Cl. G06T 15/04; G06N 3/045; G06T 17/20

(52) U.S. Cl. CPC G06T 15/04; G06N 3/045; G06T 17/20

(57) ABSTRACT

A model generation method and apparatus, an electronic device, and a storage medium are disclosed. The model generation method, includes: acquiring a first image displaying a target object; generating geometric information of the target object based on the first image by using a first network model, generating texture information of the target object based on the first image by using a second network model; and generating a model for the target object based on the geometric information of the target object and the texture information of the target object; wherein the first network model and the second network model are network models using different stem networks.

### CROSS-REFERENCE TO RELATED APPLICATION

This application claims priority to Chinese Patent Application No. 202410798614.2, filed on Jun. 20, 2024, which is incorporated herein by reference in its entirety as a part of this application.

### TECHNICAL FIELD

The present disclosure relates to the technical field of computers, in particular to a model generation method and apparatus, an electronic device, and a storage medium.

### BACKGROUND

Due to the lack of multi-view data in a single image, the techniques of generating a 3D model for an object, such as a human body, from the single image have always been unsatisfactory.

### SUMMARY

The present disclosure provides a model generation method and apparatus, an electronic device, and a storage medium.

The present disclosure adopts the following technical scheme.

In some embodiments, the present disclosure provides a model generation method, which includes:
acquiring a first image displaying a target object;
generating geometric information of the target object based on the first image by using a first network model, generating texture information of the target object based on the first image by using a second network model; and
generating a model for the target object based on the geometric information of the target object and the texture information of the target object;
wherein the first network model and the second network model are network models using different stem networks.

In some embodiments, the present disclosure provides a model generation apparatus, which includes:
an acquiring unit, configured for acquiring a first image displaying a target object;
a control unit, configured for generating geometric information of the target object based on the first image by using a first network model, generating texture information of the target object based on the first image by using a second network model; and
a generation unit, configured for generating a model for the target object based on the geometric information of the target object and the texture information of the target object;
where the first network model and the second network model are network models using different stem networks.

In some embodiments, the present disclosure provides an electronic device, which includes: at least one memory and at least one processor;
wherein the at least one memory is used for storing program codes, and the at least one processor is used for calling the program codes stored in the at least one memory, to execute a model generation method described in any one of the above.

In some embodiments, the present disclosure provides a non-transitory computer-readable storage medium, which is configured for storing program codes that, when executed by a processor, cause the processor to execute a model generation method described in any one of the above.

### BRIEF DESCRIPTION OF DRAWINGS

The above and other features, advantages, and aspects of the embodiments of the present disclosure will become more apparent in conjunction with the drawings and the following DETAILED DESCRIPTION. Throughout the drawings, identical or similar reference numbers indicate identical or similar elements. It should be understood that the drawings are schematic, and components and elements are not necessarily drawn to scale.

FIG. 1 is a flowchart of a model generation method according to the embodiment of the present disclosure;

FIG. 2 is a schematic diagram of the model generation method according to the embodiment of the present disclosure;

FIG. 3 is a schematic diagram illustrating the acquisition of 3D Gaussian texture properties according to the embodiment of the present disclosure; and

FIG. 4 is a structural schematic diagram of an electronic device according to the embodiment of the present disclosure.

### DETAILED DESCRIPTION

It is understandable that before use of the technical solutions disclosed in the embodiments of the present disclosure, the type, scope of use, and use scenarios of personal information of a user involved in the present disclosure shall be informed to the user through appropriate means in accordance with relevant laws and regulations, and authorization from the user shall be obtained.

For example, in response to reception of an active request from a user, prompt information is sent to the user to explicitly remind the user that operations that he/she requests to execute will need to acquire and use his/her personal information. As such, the user is able to choose, based on the prompt information, whether to provide personal information to software or hardware, such as electronic device, application, server, storage medium, etc., that executes the operations of the technical solutions of the present disclosure.

As an alternative, but non-limiting implementation, in response to reception of an active request from a user, the way of sending prompt information to the user may be, for example, a pop-up window in which the prompt information may be presented in the form of text. In addition, the pop-up window may also carry a selection control for the user to choose whether to “agree” or “disagree” to provide personal information to the electronic device.

It can be understood that the above-mentioned process of informing and obtaining user's authorization is merely schematic and does not constitute a limitation to the implementations of the present disclosure. Other approaches that meet relevant laws and regulations may also be applied in the implementations of the present disclosure.

It can be understood that data involved in this technical solution (including but not limited to data itself, acquisition or use of data) should comply with the requirements of relevant laws and regulations and related provisions.

The embodiments of the present disclosure will be described below in more detail with reference to the drawings. Although some embodiments of the present disclosure are shown in the drawings, it should be understood that the present disclosure can be realized in various forms and should not be construed as being limited to the embodiments set forth herein. Rather, these embodiments are provided for a more thorough and complete understanding of the present disclosure. It should be understood that the drawings and embodiments of the present disclosure are for exemplary purposes only and are not intended to limit the scope of protection of the present disclosure.

It should be understood that various steps described in the method implementation of the present disclosure may be executed sequentially and/or in parallel. In addition, the method implementation may include additional steps and/or omit the steps shown in the execution. The scope of the present disclosure is not limited in this regard.

The term “including” and its variations used herein means open inclusion, i.e., “including but not limited to”. The term “based on” is “at least partially based on”. The term “one embodiment” means “at least one embodiment”; the term “another embodiment” means “at least one further embodiment”; the term “some embodiments” means “at least some embodiments”. The relevant definitions of other terms are given in the following description.

It should be noted that the concepts “first”, “second”, etc., mentioned in the present disclosure are only used to distinguish different apparatuses, modules or units, and are not used to define the order or interdependence of the functions performed by these apparatuses, modules or units.

It should be noted that the modification “one” mentioned in the present disclosure is schematic and not limiting, and those skilled in the art should understand that this modification should be understood as “one or more” unless the context expressly indicates otherwise.

The names of messages or information exchanged among a plurality of apparatuses in the implementations of the present disclosure are for illustrative purposes only and are not intended to limit the scope of such messages or information.

The solutions provided in the embodiments of the present disclosure will be described below in detail in conjunction with the drawings.

When it comes to reconstruction techniques for generating a three-dimensional human body model from a single image, one of their challenges is to infer three-dimensional structure information from two-dimensional images in the absence of multi-view data. In related techniques, PiFu (Pixel-aligned Implicit Function) is utilized for human body reconstruction, which involves reconstructing a three-dimensional human body model with a certain fidelity from a single image on the basis of implicit functions and deep learning. The core idea of PiFu is to predict the depth value of each pixel and then use one continuous three-dimensional space function to represent human body shape and involves a capability to process a wide variety of poses and clothing. PiFu uses the mode of alignment between each pixel and an implicit surface to achieve high-precision geometric detail reconstruction. Thanks to its pixel-level processing method, PiFu is able to capture subtle surface details, such as clothing wrinkles. The disadvantage of PiFu is that its ability to process complicated scenarios is limited. When an input image contains obstructions or human body is blended with its background, it may be difficult for PiFu to accurately segment the human body, which will affect the quality of construction. Another disadvantage is limited generalization capability. Although PiFu is capable of processing different poses and clothing, its generalization capability might be limited when dealing with new scenarios that are quite different from training data. In some other techniques, Neural Radiance Fields (NeRF) are employed as a form of characterization to learn the geometry and texture of human body. Long training time for neural radiance fields (NeRF): NeRF models typically require a lot of time and computational resources to train because they need to learn high-dimensional representations of the scenarios. Limited generalization capability: NeRF models are usually trained for specific scenarios, and their generalization capability is limited with respect to new scenarios or angles that have not been seen before. Obstruction issue: at the time of dealing with complicated human body poses, especially in the presence of obstructions, NeRF may have difficulty reconstructing the obstructed parts accurately.

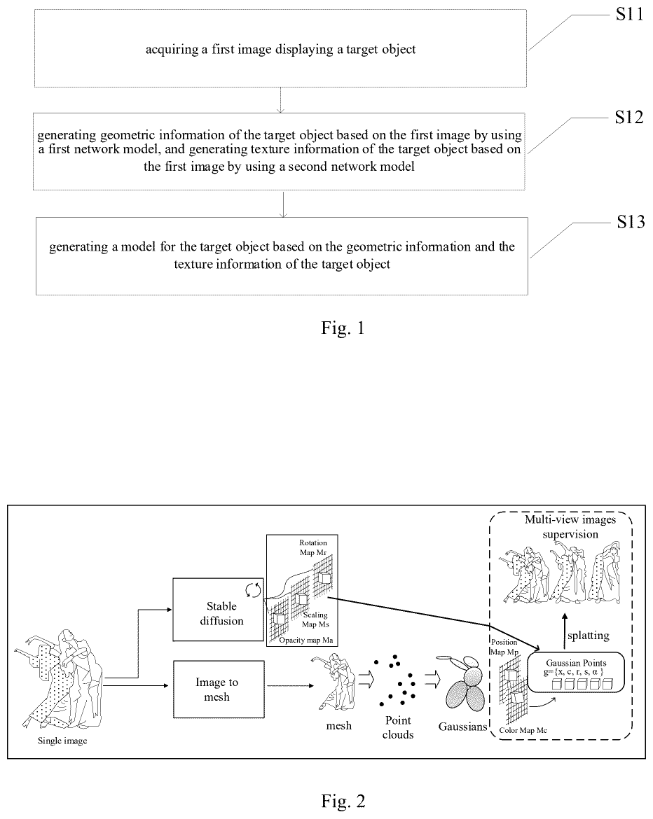

As shown in FIG. 1, FIG. 1 is a flowchart of a model generation method according to the embodiment of the present disclosure. The model generation method includes the following steps.

S11: acquiring a first image displaying a target object.

In some embodiments, the execution end for the method proposed in the present disclosure may be a terminal or a server. The target object may be human body, animals, etc. In this embodiment, only one image (i.e., the first image) of the target object needs to be acquired, the first image is a single two- dimensional image of the target object from a certain viewpoint, where the target object has the pose in the first image.

S12: generating geometric information of the target object based on the first image by using a first network model, and generating texture information of the target object based on the first image by using a second network model.

In some embodiments, the first network model and the second network model are network models using different stem networks. That is, in the embodiments of the present disclosure, network models of a same stem network are not used to acquire, from the first image, the geometric information of the target object and the texture information of the target object. Instead, network models of different stem networks are used to acquire, from the first image, the geometric information of the target object and the texture information of the target object. Specifically, decoupling is realized for the first network model and the second network model, which helps improve the overall robustness and makes the models fit for data sets of different target objects. In some embodiments, the first network model is: PiFU, PiFUHD (Pixel-Aligned Implicit Function for High-Resolution 3D Human Digitization), or an SMPL (Skinned Multi-Person Linear Model) template-based geometric reconstruction model. In some embodiments, the second network model is: a Stable Diffusion model, a DALL.E2 (Data Augmentation for Language and Vision—2) model, a DALL.E3 (Data Augmentation for Language and Vision—3) model, or an Imagen model. The geometric information characterizes the shape profile of the target object. The texture information guarantees the surface texture of the target object.

S13: generating a model for the target object based on the geometric information and the texture information of the target object.

In some embodiments, a model for the target object having the geometric information and the texture information can be constructed after the geometric information and the texture information of the target object are acquired. The model for the target object is a three-dimensional model that has complete texture information of the target object, including both the texture information of the target object displayed in the first image and the texture information of the target object not displayed in the first image. It is possible to reconstruct the geometry structure of the target object based on the geometric information and then apply the texture information of the target object to the reconstructed geometry structure.

According to the method proposed in the embodiment of the present disclosure, the texture information and the geometric information are subject to structural heterogeneous estimation for decoupling, different stem networks are used to obtain the texture information and the geometric information, which both undergo refined processing independently of each other so that overall robustness is improved and the model can be fit for the data of different target objects. By separately reconstructing the texture information and the geometric information, these two different types of information are subject to more refined processing, respectively, resulting in a better overall effect.

In some embodiments of the present disclosure, by using related techniques, the geometric information of the target object may be acquired from the first image for purposes of geometric reconstruction of the target object. The second network model is a diffusion theory-based network model. Since the second network model is based on diffusion theory, the second network model is a network model capable of completing the texture information of an invisible region or an incomplete region of the target object in the first image, and refined texture reconstruction is carried out such that the invisible region of the target object can be effectively predicted and restored and better reconstruction for the three- dimensional model of the target object can be achieved.

In some embodiments of the present disclosure, generating texture information of the target object based on the first image by using a second network model includes: performing texture initialization on texture information of a visible region of the target object in the first image by using the second network model; and completing texture information of an invisible region or an incomplete region of the target object in the first image by using the second network model, to obtain the texture information of the target object.

In some embodiments, after one single first image of the target object is acquired, this first image is taken as an input. A diffusion model is utilized to begin texture information initialization of the visible region on the target object in the first image. Then, for the texture information of the invisible or incomplete region of the target object, denoising and completion for the texture information is carried out by use of the diffusion model, thus ensuring the consistency and completeness of the texture information.

In some embodiments of the present disclosure, completing texture information of an invisible region or an incomplete region of the target object in the first image by using the second network model, to obtain the texture information of the target object, includes: inputting the first image, a Gaussian noise, a weighting function, and a network weight into the second network model, where the weighting function is used to calculate a distribution of the Gaussian noise with different iteration steps; performing, by the second network model, T-step denoising iteration based on input parameters that are input into the second network model, to obtain 3D Gaussian texture properties of the target object; where T is a positive integer and the texture information of the target object includes the 3D Gaussian texture properties.

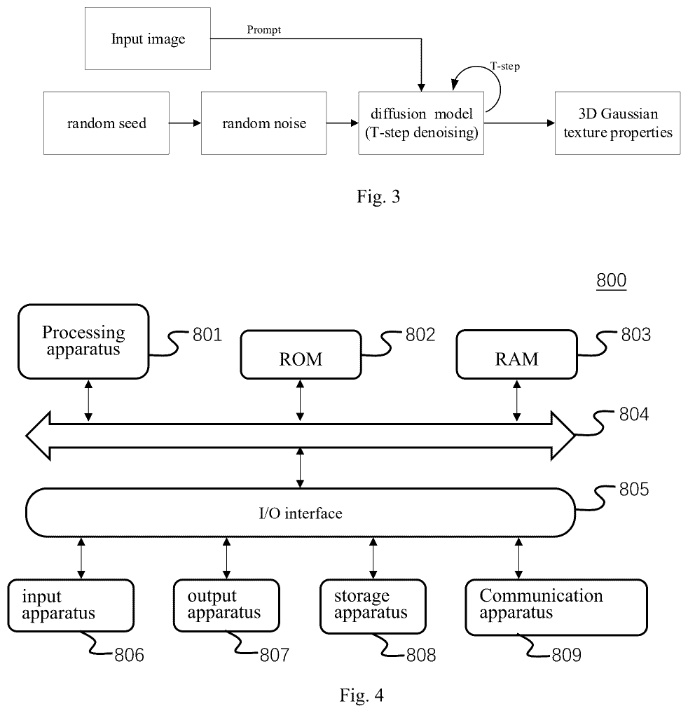

In some embodiments, in order to accurately reconstruct the texture information, the diffusion theory-based second network model is used. This model performs well in transfer and perfection of texture information processing, and in particular can significantly improve the quality of reconstruction when reconstructing the texture of invisible portions. Such a diffusion model method greatly improves the stability and robustness in dealing with reconstruction tasks under variable scenarios and different environmental conditions. The output from this model can be expressed as: G_{diffused}=D(W; I_{original}+ϵ·w(t)), where I_{original} represents first image, ϵ represents Gaussian noise, w(t) represents weighting function, t is the t-th denoising iteration, D represents second network model, W identifies network weight, T is total denoising iteration step, which is often a multi-steps, e.g., 20 to 30 steps, t is not greater than T, the output from the model is 3D Gaussian texture properties corresponding to {Gᵢ}^{N}ᵢ₌₁, and G_{diffused} is color information and shape information of 3D Gaussian. The process of generating the 3D Gaussian texture properties is described with respect to FIG. 2 and FIG. 3. As for specific execution of this process, 1: First image I_{original} is acquired at first, and the first image is the Single image in FIG. 2 and also an input image in FIG. 3. 2: Noise injection is performed. At the beginning of every denoising iteration, a time-varying weighting function w(t) is calculated from the current iteration step t and then multiplied by Gaussian noise ϵ to get a noise item ϵ·w(t) specific to the current step t, and the Gaussian noise may be a random noise generated using random seeds. This noise item is added onto the first image I_{original} to create a new image with an adjusted noise level. 3: Denoising network processing is executed: the noisy image that results from the previous step is regarded as the input to a denoising network D (stable Diffusion in FIG. 2, diffusion model in FIG. 3) and meanwhile, the network will make use of its internal parameter W. The task of the denoising network D is to recover as much clear content as possible from the noisy image, especially the color and shape information related to the 3D Gaussian texture properties. 4: Output: output G of the network represents the denoised color information and shape information of 3D Gaussian extracted from the image under the current iteration step, and with each denoising iteration, output G should get closer and closer to noiseless and detail-rich 3D Gaussian parameters. 5. Iteration: this process will be repeated during the time when time step t increases from 0 to a predetermined maximum step T (e.g., 20 to 30). Each iteration attempts to further reduce noise on the basis of the previous iteration, while maintaining or enhancing real-world features, especially those associated with 3D Gaussian distribution. 6. Results: after the final iteration step T is reached, the output G of the last iteration is the final processing result, which theoretically should be a high-quality, high-definition-texture 3D Gaussian representation that clearly expresses 3D Gaussian texture properties (3D Gaussian texture properties include: color information and shape information of 3D Gaussian) in the original image I. In nature, the 3D Gaussian representation is still a 3D representation, and splatting is required to obtain a high-quality image representation. In this embodiment, as an innovative proposal, the diffusion theory-based network model is used to generate 3D Gaussian texture properties. As this model is a diffusion theory-based network model, 3D Gaussian texture properties can be obtained without using multi-view images, and the requirements for the input image are lowered as compared to related techniques in which 3D Gaussian texture properties are obtained through the use of multi-view images. This model performs well in transfer and perfection of texture information processing, and in particular can significantly improve the quality of reconstruction when reconstructing the texture of the invisible region in the image.

In some embodiments of the present disclosure, in the process of any step denoising iteration of the second network model, the output by this step denoising iteration is 3D Gaussian color and shape information resulting from this step denoising iteration, with no generation of the image of the target object. In this embodiment, unlike the way of generating an image in iteration steps to serve as the output from the iteration process in related techniques, the denoising iteration process in this embodiment is modified and the output G of the denoising iteration process is the noiseless and detail-rich 3D Gaussian properties. Because the image generation task has been changed to a task of generating 3D Gaussian properties, there is no need for image rendering in the iteration process, which not only reduces the processing amount but also omits geometric parameter-related processing so that the entire iteration process focuses on 3D Gaussian properties.

In some embodiments of the present disclosure, generating geometric information of the target object based on the first image by using a first network model includes: constructing a mesh structure of the target object based on the first image by using the first network model; sampling a plurality of point clouds from a surface of the mesh structure; and taking respective point clouds as Gaussian points, initializing the Gaussian points to form an initial three-dimensional Gaussian point cloud.

In some embodiments, as shown in FIG. 2, single image is the first image, the target object in the first image is human body, image to mesh is a process of generating the mesh by using the second network model, and the mesh structure (mesh in FIG. 2) is thus obtained. Then, point clouds (point clouds in FIG. 2) are obtained by sampling from the mesh structure, followed by taking the various point clouds as Gaussian points and initializing the Gaussian points to form an initial three-dimensional Gaussian point cloud (Gaussians on the right of point clouds in FIG. 2). In this embodiment, higher precision and higher similarity to the real-world appearance of the target object are realized by extraction of locations of the point clouds from the mesh structure and geometric model refining. In some embodiments, the geometric information is used to establish a three-dimensional geometry of the target object. The parameters of a 3D geometric shape can be estimated through a deep neural network model. These parameters define the geometric features of the target object's shape and are used to guide subsequent reconstruction steps. To initialize the 3D Gaussian model, 27,000 Gaussian points are uniformly sampled from the mesh structure, and these Gaussian points are taken as the center of the 3D Gaussian model (3D Gaussian Splatting), with an aim to capture the global distribution and local details of the geometry of the target object. Let θ be a parameter set for the geometric shape of the target object. The geometric parameter of the target object output by the first network model is θ=f(I; W), where I is the input first image, f is the geometrically reconstructed network (i.e., the first network model), and W identifies network weight. In the process of point cloud sampling, the three-dimensional mesh structure (Mesh) is sampled as point clouds. Specifically, a set of discrete points may be chosen on the surface of the mesh structure, with these points roughly retaining the geometric and topological properties of the original mesh structure. This process is broken down into mathematical steps: let M be a three-dimensional mesh structure that consists of a set of vertices V and a set of edges E and faces F connecting these vertices. Based upon the chosen strategy, in a case where vertex coordinates on each triangular face f (f belongs to F) in the mesh structureare v1, v2 and v3, the interpolation calculation process for a sample point pj is as follows: pj=λ1* v1+λ2* v3+λ3*v4, where λ1, λ2, and λ3 are independently greater than or equal to zero and the sum of the three is 1. In the process of initialization for the 3D Gaussian points, 27,000 Gaussian points Gᵢ are chosen, with the maximum number of i being 27000, and these Gaussian points are initialized to cover the geometric space of the target object so as to form one initial three-dimensional Gaussian point cloud. With this method, the deep network combined with the 3D Gaussian model can effectively reconstruct accurate geometric information of the target object.

In some embodiments of the present disclosure, generating a model for the target object based on the geometric information and the texture information of the target object includes: merging the initial three-dimensional Gaussian point cloud and the texture information of the target object to obtain 3D Gaussian parameters of the target object, where the 3D Gaussian parameters of the target object are taken as a model representation of the target object. In some embodiments, the initial three-dimensional Gaussian point cloud and the 3D Gaussian properties of the target object are merged to obtain the 3D Gaussian parameters of the target object. The 3D Gaussian parameters of the target object are taken as a model representation of the target object. The 3D Gaussian parameters may be used to create the 3D Gaussian model for the target object, and may also be directly used as a parameter representation of the model for the target object.

In some embodiments of the present disclosure, the following is further included: generating generation images of the target object from a plurality of different viewpoints by using the 3D Gaussian parameters of the target object; and performing convergent training on the 3D Gaussian parameters by using the generation images and second images of the target object, to optimize the 3D Gaussian parameters of the target object; wherein each generation image has a corresponding second picture, and the corresponding second picture is a real image with a same viewpoint as a viewpoint of the target object in the generation image.

In some embodiments, the Gaussian parameters of the target object are projected to various viewpoints to obtain generation images, and the generation images are images, from different viewpoints, of the target object that are generated by simulation, e.g., Muti-view images supervision as shown in the upper right corner of FIG. 2. The pose of the target object in the generation image is the same as or different from the pose of the target object in the first image, a loss function is then created from the generation images and second images having different viewpoints, and the 3D Gaussian parameters are optimized until the model converges. Specifically, the number of the generation images may be the same as the number of the second images, one generation image has one corresponding second image and also has the same viewpoint as that of the corresponding second image, a difference between one generation image and one corresponding second image that share the same viewpoint is calculated, the sum of all the differences is calculated as the total loss function, and the 3D Gaussian parameters are optimized until the total loss function is minimized or the number of iterations is reached.

In some embodiments of the present disclosure, the texture information and the geometric information are decoupled: by decoupling the texture information with the geometric information and selecting the most suitable network models for reconstruction and rendering with respect to their respective characteristics, the quality of three-dimensional reconstruction and the processing procedure are both optimized, thereby offering higher efficiency and better practicability. The first network may be a network model that generates the most accurate geometric information from a single image and the second network model may be a network model that generates the most accurate texture information (including the texture information of the visible, invisible and incomplete regions) from a single image, as a result of which the model for the target object generated from a single image possesses the best quality. And excellent robustness and adaptability in complicated scenarios can be attained.

In some embodiments of the present disclosure, upon acquisition of the texture information, an image diffusion theory-based prediction mechanism is employed to effectively predict and restore the invisible region of the target object, achieving a better effect for the task of three-dimensional target object reconstruction.

In terms of the reconstruction of 3D representations, a 3D Gaussian model (3D Gaussian Splatting) is used to improve the quality and speed of rendering. Such an approach may allow for fast and accurate rendering of three-dimensional configurations and is suitable for scenarios where rapid generation of high-quality three-dimensional images is desired.

The present disclosure further provides a model generation apparatus, which includes:
an acquiring unit, configured for acquiring a first image displaying a target object;
a control unit, configured for generating geometric information of the target object based on the first image by using a first network model, generating texture information of the target object based on the first image by using a second network model; and
a generation unit, configured for generating a model for the target object based on the geometric information of the target object and the texture information of the target object;
where the first network model and the second network model are network models using different stem networks.

In some embodiments, the second network model is a diffusion theory-based network model.

In some embodiments, the generating texture information of the target object based on the first image by using a second network model, includes:
performing texture initialization on texture information of a visible region of the target object in the first image by using the second network model; and
completing texture information of an invisible region or an incomplete region of the target object in the first image by using the second network model, to obtain the texture information of the target object.

In some embodiments, the completing texture information of an invisible region or an incomplete region of the target object in the first image by using the second network model, to obtain the texture information of the target object, includes:
inputting the first image, a Gaussian noise, a weighting function, and a network weight into the second network model, wherein the weighting function is used to calculate a distribution of the Gaussian noise with different iteration steps;
performing, by the second network model, T-step denoising iteration based on input parameters that are input into the second network model, to obtain 3D Gaussian texture properties of the target object;
where T is a positive integer and the texture information of the target object comprises the 3D Gaussian texture properties.

In some embodiments, in a process of any step denoising iteration of the T-step denoising iteration performed by the second network model, an output from the any step denoising iteration is color information and shape information of 3D Gaussian resulting from the any step denoising iteration, without generating an image of the target object.

In some embodiments, the 3D Gaussian texture properties comprise: the color information and the shape information of 3D Gaussian.

In some embodiments, the generating geometric information of the target object based on the first image by using a first network model, includes:
constructing a mesh structure of the target object based on the first image by using the first network model;
sampling point clouds from a surface of the mesh structure; and
taking respective point clouds as Gaussian points, initializing the Gaussian points to form an initial three-dimensional Gaussian point cloud.

In some embodiments, generating a model for the target object based on the geometric information and the texture information of the target object, includes:
merging the initial three-dimensional Gaussian point cloud and the texture information of the target object to obtain 3D Gaussian parameters of the target object, wherein the 3D Gaussian parameters of the target object are taken as a model representation of the target object.

In some embodiments, after the 3D Gaussian parameters of the target object are obtained, the control unit is further configured for:
generating generation images of the target object from a plurality of different viewpoints by using the 3D Gaussian parameters of the target object; and
performing convergent training on the 3D Gaussian parameters by using the generation images and second images of the target object, to optimize the 3D Gaussian parameters of the target object, wherein each generation image has a corresponding second image, and the corresponding second image is a real image with a same viewpoint as a viewpoint of the target object in the generation image.

In some embodiments, the first network model is: PiFU, PiFUHD, or an SMPL template-based geometric reconstruction model. In some embodiments, the second network model is: a Stable Diffusion model, a DALL.E2 model, a DALL.E3 model, or an Imagen model.

For the embodiment of the apparatus, since it basically corresponds to the method embodiment, it is only necessary to refer to part of the description of the method embodiment for relevant points. The device embodiments described above are only schematic, wherein the modules described as separate modules may or may not be separate. Some or all of the modules can be selected according to actual needs to achieve the purpose of this embodiment. Ordinary technicians in this field can understand and implement it without creative labor.

The method and apparatus of the present disclosure have been illustrated hereinabove on the basis of embodiments and application examples. In addition, also provided in the present disclosure are an electronic device and a computer-readable storage medium, which will be illustrated hereinbelow.

Reference is made below to FIG. 4 that illustrates a structural schematic diagram of an electronic device (e.g., terminal device or server) 800 suited to implement the embodiment of the present disclosure. The terminal device in the embodiment of the present disclosure may include, but is not limited to, mobile terminals such as mobile phone, laptop, digital radio receiver, PDA (Personal Digital Assistant), PAD (Portable Android Device), PMP (Portable Media Player), in-vehicle terminal (e.g., in-vehicle navigation terminal), etc., and fixed terminals such as digital TV, desktop computer, etc. The electronic device shown in the drawing is merely an example and should not impose any limitation on the functionality and scope of use of the embodiments of the present disclosure.

The electronic device 800 may include a processing apparatus (e.g., a central processing unit, a graphics processing unit, etc.) 801, which can perform various appropriate actions and processes according to a program stored in Read Only Memory (ROM) 802 or a program loaded into Random Access Memory (RAM) 803 from a storage apparatus 808. In RAM 803, various programs and data required for the operation of the electronic device 800 are also stored. The processing unit 801, ROM 802 and RAM 803 are connected with each other via a bus 804. An input/output (I/O) interface 805 is also connected to the bus 804.

In general, the following apparatuses can be connected to the I/O interface 805: an input apparatus 806 including, for example, touch screen, touch pad, keyboard, mouse, camera, microphone, accelerometer, gyroscope, etc.; an output apparatus 808 including, for example, liquid crystal display (LCD), speaker, vibrator, etc.; a storage apparatus 808 including, for example, magnetic tape, hard disk, etc.; and a communication apparatus 809. The communication apparatus 809 may allow the electronic device 800 to communicate, wirelessly or in a wired manner, with other devices for data exchange. Although the electronic device 800 having various apparatuses is shown in the drawing, it should be understood that it is not required to implement or have all of the apparatuses shown. It is possible to alternatively implement or have more or fewer apparatuses.

In particular, according to the embodiments of the present disclosure, the process described above with respect to the flowchart may be implemented as a computer software program. For example, included in the embodiment of the present disclosure is a computer program product that includes a computer program carried on a computer-readable medium, and this computer program contains program codes for execution of the method shown in the flowchart. In such an embodiment, this computer program may be downloaded and installed from a network through the communication apparatus 809, or installed from the storage apparatus 808, or installed from ROM 802. When this computer program is executed by the processing apparatus 801, the above functions defined in the method of the embodiment of the present disclosure are executed.

It should be noted that the computer-readable medium described above in the present disclosure may be a computer-readable signal medium, or a computer-readable storage medium, or any combination of the both. For example, the computer-readable storage medium may be, but not limited to, electric, magnetic, optical, electromagnetic, infrared, or semiconductor systems, apparatuses or devices, or any combination thereof. More specific examples of the computer-readable storage medium may include, but not limited to, electrical connection with one or more wires, portable computer disk, hard disk, random access memory (RAM), read-only memory (ROM), erasable programmable read-only memory (EPROM or flash), optical fiber, compact disk read-only memory (CD-ROM), optical storage device, magnetic storage device, or any appropriate combination of the above. In the present disclosure, the computer-readable storage medium may be any tangible medium containing or storing a program that may be used by or in combination with an instruction execution system, apparatus or device. In the present disclosure, the computer-readable signal medium may include a data signal propagated in baseband or as part of a carrier wave, and this data signal carries computer-readable program codes therein. This propagating data signal can take many forms, including but not limited to electromagnetic signal, optical signal, or any suitable combination of the above. The computer-readable signal medium may also be any computer-readable medium other than the computer-readable storage medium, and this computer-readable signal medium may send, communicate or transmit programs intended for use by or in combination with an instruction execution system, apparatus or device. Program codes contained on the computer-readable medium may be transmitted using any appropriate medium, including but not limited to electric wire, optical cable, RF (radio frequency), etc., or any suitable combination of the above.

In some implementations, clients and servers may communicate using any currently-known or future-developed network protocol such as HTTP (HyperText Transfer Protocol), and may be interconnected with digital data communication (e.g., a communication network) in any form or medium. Examples of the communication network include local area network (“LAN”), wide area network (“WANs”), internetwork (e.g., Internet), and end-to-end network (e.g., ad hoc end-to-end network), as well as any network that is currently known or developed in the future.

The computer-readable medium described above may be contained in the above electronic device, and may also exist independently, without being incorporated into this electronic device.

The computer-readable medium described above carries one or more programs, and when the one or more programs described above are executed by this electronic device, this electronic device is caused to perform the above method of the present disclosure.

Computer program codes for execution of the operations of the present disclosure may be written in one or more programming languages, or combinations thereof, and the above programming languages include object-oriented programming languages, such as Java, Smalltalk, C++, and also include conventional procedural programming languages, such as “C” language or similar programming languages. Program codes may be executed entirely on a user computer, partly on the user computer, as a standalone software package, partly on the user computer and partly on a remote computer, or entirely on the remote computer or a server. In a case where a remote computer is involved, the remote computer can be connected to the user computer through any type of network, including local area network (LAN) or wide area network (WAN), or to an external computer (e.g., using an Internet service provider for connection over Internet).

The flowcharts and block diagrams in the drawings illustrate the architectures, functions, and operations that may be realized in accordance with the systems, methods, and computer program products of various embodiments of the present disclosure. In this regard, each block in the flowchart or block diagram may represent part of a module, program segment, or code that contains one or more executable instructions for implementing specified logical functions. It should also be noted that in some alternative implementations, the functions indicated in the blocks may also occur in a different order than those indicated in the drawing. For example, two blocks that are shown in succession may actually be executed substantially in parallel, and may sometimes be executed in a reverse order, depending on the functions involved. It should also be noted that each block in the block diagram and/or flowchart, as well as combinations of the blocks in the block diagram and/or flowchart, may be implemented with a dedicated hardware-based system that performs specified functions or operations, or with a combination of specialized hardware and computer instructions.

The involved units that are described in the embodiments of the present disclosure may be realized by means of software or hardware. In a particular case, the name of a unit does not constitute a limitation to this unit itself.

The functions described above in this document may be performed at least partially by one or more hardware logic parts. For example, and without limitations, exemplary types of the hardware logic parts that may be used include: field-programmable gate array (FPGA), application-specific integrated circuit (ASIC), application-specific standard product (ASSP), system-on-chip (SOC), complex programmable logic device (CPLD), etc.

In the context of the present disclosure, a machine-readable medium may be a tangible medium that may contain or store programs for use by or in combination with an instruction execution system, apparatus or device. The machine-readable medium may be either a machine-readable signal medium or a machine-readable storage medium. The machine-readable medium may include, but are not limited to, electronic, magnetic, optical, electromagnetic, infrared, or semiconductor systems, apparatuses, or devices, or any suitable combination of the above. More specific examples of the machine-readable storage medium would include electrical connection based on one or more wires, portable computer disk, hard disk, random access memory (RAM), read-only memory (ROM), erasable programmable read-only memory (EPROM or flash memory), optical fiber, compact disk read-only memory (CD-ROM), optical storage device, magnetic storage device, or any suitable combination of the above.

According to one or more embodiments or the present disclosure, a model generation method is provided and includes:
acquiring a first image displaying a target object;
generating geometric information of the target object based on the first image by using a first network model, generating texture information of the target object based on the first image by using a second network model; and
generating a model for the target object based on the geometric information of the target object and the texture information of the target object;
wherein the first network model and the second network model are network models using different stem networks.

According to one or more embodiments or the present disclosure, a model generation method is provided, wherein the second network model is a diffusion theory-based network model.

According to one or more embodiments or the present disclosure, a model generation method is provided, wherein the generating texture information of the target object based on the first image by using a second network model, includes:
performing texture initialization on texture information of a visible region of the target object in the first image by using the second network model; and
completing texture information of an invisible region or an incomplete region of the target object in the first image by using the second network model, to obtain the texture information of the target object.

According to one or more embodiments or the present disclosure, a model generation method is provided, wherein the completing texture information of an invisible region or an incomplete region of the target object in the first image by using the second network model, to obtain the texture information of the target object, includes:
inputting the first image, a Gaussian noise, a weighting function, and a network weight into the second network model, wherein the weighting function is used to calculate a distribution of the Gaussian noise with different iteration steps;
performing, by the second network model, T-step denoising iteration based on input parameters that are input into the second network model, to obtain 3D Gaussian texture properties of the target object;
wherein T is a positive integer and the texture information of the target object comprises the 3D Gaussian texture properties.

According to one or more embodiments or the present disclosure, a model generation method is provided, wherein in a process of any step denoising iteration of the T-step denoising iteration performed by the second network model, an output from the any step denoising iteration is color information and shape information of 3D Gaussian resulting from the any step denoising iteration, without generating an image of the target object.

According to one or more embodiments or the present disclosure, a model generation method is provided, wherein the 3D Gaussian texture properties include: the color information and the shape information of 3D Gaussian.

According to one or more embodiments or the present disclosure, a model generation method is provided, wherein the generating geometric information of the target object based on the first image by using a first network model, includes:
constructing a mesh structure of the target object based on the first image by using the first network model;
sampling point clouds from a surface of the mesh structure; and
taking respective point clouds as Gaussian points, initializing the Gaussian points to form an initial three-dimensional Gaussian point cloud.

According to one or more embodiments or the present disclosure, a model generation method is provided, wherein generating a model for the target object based on the geometric information and the texture information of the target object, includes:
merging the initial three-dimensional Gaussian point cloud and the texture information of the target object to obtain 3D Gaussian parameters of the target object, wherein the 3D Gaussian parameters of the target object are taken as a model representation of the target object.

According to one or more embodiments or the present disclosure, a model generation method is provided, wherein, after the 3D Gaussian parameters of the target object are obtained, the method further comprises:
generating generation images of the target object from a plurality of different viewpoints by using the 3D Gaussian parameters of the target object; and
performing convergent training on the 3D Gaussian parameters by using the generation images and second images of the target object, to optimize the 3D Gaussian parameters of the target object;
wherein each generation image has a corresponding second image, and the corresponding second image is a real image with a same viewpoint as a viewpoint of the target object in the generation image.

According to one or more embodiments or the present disclosure, a model generation method is provided, wherein the first network model is: PiFU, PiFUHD, or an SMPL template-based geometric reconstruction model; and/or

According to one or more embodiments or the present disclosure, a model generation method is provided, wherein the second network model is: a Stable Diffusion model, a DALL.E2 model, a DALL.E3 model, or an Imagen model.

According to one or more embodiments or the present disclosure, a model generation apparatus is provided, which includes:
an acquiring unit, configured for acquiring a first image displaying a target object;
a control unit, configured for generating geometric information of the target object based on the first image by using a first network model, generating texture information of the target object based on the first image by using a second network model; and
a generation unit, configured for generating a model for the target object based on the geometric information of the target object and the texture information of the target object;
where the first network model and the second network model are network models using different stem networks.

According to one or more embodiments or the present disclosure, an electronic device is provided, which includes: at least one memory and at least one processor;
wherein the at least one memory is used for storing program codes, and the at least one processor is used for calling the program codes stored in the at least one memory, to execute a model generation method described in any one of the above.

According to one or more embodiments or the present disclosure, a non-transitory computer-readable storage medium is provided, the non-transitory computer-readable storage medium is configured for storing program codes that, when executed by a processor, cause the processor to execute a model generation method described in any one of the above.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure.

Furthermore, although operations are depicted in a particular order, this should not be understood as requiring that these operations be performed in the particular order shown or in a sequential order.

Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and acts described above are only exemplary forms of implementing the claims.

1. A model generation method, comprising:
acquiring a first image displaying a target object;
generating geometric information of the target object based on the first image by using a first network model, generating texture information of the target object based on the first image by using a second network model; and
generating a model for the target object based on the geometric information of the target object and the texture information of the target object;
wherein the first network model and the second network model are network models using different stem networks.

2. The method according to claim 1, wherein the second network model is a diffusion theory-based network model.

3. The method according to claim 1, wherein the generating texture information of the target object based on the first image by using a second network model, comprises:
performing texture initialization on texture information of a visible region of the target object in the first image by using the second network model; and
completing texture information of an invisible region or an incomplete region of the target object in the first image by using the second network model, to obtain the texture information of the target object.

4. The method according to claim 3, wherein the completing texture information of an invisible region or an incomplete region of the target object in the first image by using the second network model, to obtain the texture information of the target object, comprises:
inputting the first image, a Gaussian noise, a weighting function, and a network weight into the second network model, wherein the weighting function is used to calculate a distribution of the Gaussian noise with different iteration steps;
performing, by the second network model, T-step denoising iteration based on input parameters that are input into the second network model, to obtain 3D Gaussian texture properties of the target object;
wherein T is a positive integer and the texture information of the target object comprises the 3D Gaussian texture properties.

5. The method according to claim 4, wherein
in a process of any step denoising iteration of the T-step denoising iteration performed by the second network model, an output from the any step denoising iteration is color information and shape information of 3D Gaussian resulting from the any step denoising iteration, without generating an image of the target object; and/or
the 3D Gaussian texture properties comprise: the color information and the shape information of 3D Gaussian.

6. The method according to claim 1, wherein the generating geometric information of the target object based on the first image by using a first network model, comprises:
constructing a mesh structure of the target object based on the first image by using the first network model;
sampling point clouds from a surface of the mesh structure; and
taking respective point clouds as Gaussian points, initializing the Gaussian points to form an initial three- dimensional Gaussian point cloud.

7. The method according to claim 6, wherein generating a model for the target object based on the geometric information and the texture information of the target object, comprises:
merging the initial three-dimensional Gaussian point cloud and the texture information of the target object to obtain 3D Gaussian parameters of the target object, wherein the 3D Gaussian parameters of the target object are taken as a model representation of the target object.

8. The method according to claim 7, wherein, after the 3D Gaussian parameters of the target object are obtained, the method further comprises:
generating generation images of the target object from a plurality of different viewpoints by using the 3D Gaussian parameters of the target object; and
performing convergent training on the 3D Gaussian parameters by using the generation images and second images of the target object, to optimize the 3D Gaussian parameters of the target object;
wherein each generation image has a corresponding second image, and the corresponding second image is a real image with a same viewpoint as a viewpoint of the target object in the generation image.

9. The method according to claim 1, wherein
the first network model is: PiFU, PiFUHD, or an SMPL template-based geometric reconstruction model; and/or
the second network model is: a Stable Diffusion model, a DALL.E2 model, a DALL.E3 model, or an Imagen model.

10. An electronic device, comprising:
at least one memory and at least one processor;
wherein the at least one memory is used for storing program codes, and the at least one processor is used for calling the program codes stored in the at least one memory, to execute a model generation method;
wherein the model generation method comprises:
acquiring a first image displaying a target object;
generating geometric information of the target object based on the first image by using a first network model, generating texture information of the target object based on the first image by using a second network model; and
generating a model for the target object based on the geometric information of the target object and the texture information of the target object;
wherein the first network model and the second network model are network models using different stem networks.

11. The electronic device according to claim 10, wherein the second network model is a diffusion theory- based network model.

12. The electronic device according to claim 10, wherein the generating texture information of the target object based on the first image by using a second network model, comprises:
performing texture initialization on texture information of a visible region of the target object in the first image by using the second network model; and
completing texture information of an invisible region or an incomplete region of the target object in the first image by using the second network model, to obtain the texture information of the target object.

13. The electronic device according to claim 12, wherein the completing texture information of an invisible region or an incomplete region of the target object in the first image by using the second network model, to obtain the texture information of the target object, comprises:
inputting the first image, a Gaussian noise, a weighting function, and a network weight into the second network model, wherein the weighting function is used to calculate a distribution of the Gaussian noise with different iteration steps;
performing, by the second network model, T-step denoising iteration based on input parameters that are input into the second network model, to obtain 3D Gaussian texture properties of the target object;
wherein T is a positive integer and the texture information of the target object comprises the 3D Gaussian texture properties.

14. The electronic device according to claim 13, wherein
in a process of any step denoising iteration of the T-step denoising iteration performed by the second network model, an output from the any step denoising iteration is color information and shape information of 3D Gaussian resulting from the any step denoising iteration, without generating an image of the target object; and/or
the 3D Gaussian texture properties comprise: the color information and the shape information of 3D Gaussian.

15. The electronic device according to claim 10, wherein the generating geometric information of the target object based on the first image by using a first network model, comprises:
constructing a mesh structure of the target object based on the first image by using the first network model;
sampling point clouds from a surface of the mesh structure; and
taking respective point clouds as Gaussian points, initializing the Gaussian points to form an initial three- dimensional Gaussian point cloud.

16. The electronic device according to claim 15, wherein generating a model for the target object based on the geometric information and the texture information of the target object, comprises:
merging the initial three-dimensional Gaussian point cloud and the texture information of the target object to obtain 3D Gaussian parameters of the target object, wherein the 3D Gaussian parameters of the target object are taken as a model representation of the target object.

17. The electronic device according to claim 16, wherein, after the 3D Gaussian parameters of the target object are obtained, the method further comprises:
generating generation images of the target object from a plurality of different viewpoints by using the 3D Gaussian parameters of the target object; and
performing convergent training on the 3D Gaussian parameters by using the generation images and second images of the target object, to optimize the 3D Gaussian parameters of the target object;
wherein each generation image has a corresponding second image, and the corresponding second image is a real image with a same viewpoint as a viewpoint of the target object in the generation image.

18. The electronic device according to claim 10, wherein
the first network model is: PiFU, PiFUHD, or an SMPL template-based geometric reconstruction model; and/or
the second network model is: a Stable Diffusion model, a DALL.E2 model, a DALL.E3 model, or an Imagen model.

19. A non-transitory computer-readable storage medium for storing program codes that, when executed by a processor, cause the processor to execute a model generation method;
wherein the model generation method comprises:
acquiring a first image displaying a target object;
generating geometric information of the target object based on the first image by using a first network model, generating texture information of the target object based on the first image by using a second network model; and
generating a model for the target object based on the geometric information of the target object and the texture information of the target object;
wherein the first network model and the second network model are network models using different stem networks.

20. The non-transitory computer-readable storage medium according to claim 19, wherein the second network model is a diffusion theory-based network model.
